(19) United States
(12) Patent Application Publication
(10) Pub. No.: US 2013/0262799 A1
(43) Pub. Date: Oct. 3, 2013

(54) CONTROL METHOD AND STORAGE DEVICE

(71) Applicant: FUJITSU LIMITED, Kawasaki-shi (JP)

(72) Inventor: Hironori Saito, Yokohama (JP)

(73) Assignee: FUJITSU LIMITED, Kawasaki-shi (JP)

(21) Appl. No.: 13/743,459

(22) Filed: Jan. 17, 2013

(30) Foreign Application Priority Data
Mar. 30, 2012 (JP) 2012-079549

(51) Int. Cl. G06F 3/06

(52) U.S. Cl. CPC G06F 3/0644
USPC 711/161

(57) ABSTRACT

A method of controlling a storage device including a storage unit, comprises receiving a plurality of pieces of divided data which is generated by dividing first data according to data length information indicating a data length determined based on writing units in which data is to be written in a storage unit and which is assigned number information identifying an order of locations in the first data to each of the pieces of divided data, storing the plurality of pieces of received divided data in a free storage area capable of storing the data in the storage unit, reading out the plurality of pieces of stored divided data from the storage unit and storing the read plurality of pieces of divided data into a continuous free storage area in the storage unit in an order indicated by the number information.

### CROSS-REFERENCE TO RELATED APPLICATION(S)

This application is based upon and claims the benefit of priority of the prior Japanese Patent Application No. 2012-079549, filed on Mar. 30, 2012, the entire contents of which are incorporated herein by reference.

### FIELD

The embodiments discussed herein are related to a computer-readable non-transitory medium, a control method, a storage device, and a system.

### BACKGROUND

When a host computer (hereinafter also referred to simply as a host) such as a server apparatus writes data in a storage device, the host transmits a plurality of commands to the storage device (or a control apparatus that controls the storage device).

Each command specifies a location in a storage area of the storage device at which data based on the command is to be stored, wherein the location is specified by a start address and a data length as measured from the start address.

Data to be written in the storage area based on one command has a specified data length, and the data with the specified data length is written in a continuous storage area in the storage device. When the data is read out, the data is specified by the start address and the data length as measured from the start address. Therefore, if the data specified by one command is not stored continuously, it may become difficult to read out the data.

FIG. 17 illustrates a conventional example. In FIG. 17, one block in a storage area of a storage device is set to be, by way of example, 256 KB in length. In the specific example illustrated in FIG. 17, data B with a length of 80 KB is already stored in one block.

In the state illustrated in FIG. 17, let it be assumed that a command is issued to write data A with a data length of 144 KB in this block. In the state illustrated in FIG. 17, it is not allowed to store the data in this block because a greatest size of continuous free storage areas in this block is 80 KB and thus the block does not provide a continuous storage area available for storing the data A with the data length of 144 KB.

An SSD (Solid State Drive) apparatus is known as one type of storage devices.

When the state descried above occurs in the SSD apparatus, a garbage collection process is performed to create a free storage area in the block available for continuously storing the data A.

To perform the garbage collection in a state such as that illustrated in FIG. 17, the SSD apparatus first makes a copy of the existing data B in a free storage area in another block (hereinafter referred to as a second block, and the block described previously is referred to as the first block). After the data B is copied in the free storage area in the second block, the SSD apparatus deletes the data B from the first block. Note that according to specifications of the SSD apparatus, deleting data is supposed to be performed in units of blocks. Therefore, the SSD apparatus deletes all data including the data B from the first block. In this way, the SSD apparatus creates a continuous storage area capable of storing the data A. The garbage collection process is performed as a background process when the SSD apparatus is in operation. A known specific method of the garbage collection may be founded, for example, in Japanese Laid-open Patent Publication No. 11-126488.

The SSD apparatus includes, for example, a nonvolatile memory (such as a flash memory) used as the data storage area described above and a volatile memory used as a cache memory. When creating a free storage area by the garbage collection process is not complete in time, the SSD apparatus temporarily stores the data specified by the command in the cache memory. When the continuous free storage area available for storing the data is created by the garbage collection process, the SSD apparatus performs a process of storing the data held in the cache memory into the obtained free storage area.

However, in such a case, because received data is once held in the cache memory before the data is stored in the data storage area, an increase occurs in time spent since the reception of data till the end of writing of the data in the data storage area of the SSD apparatus.

Besides, when the length of data to be stored is large and thus the free storage area of the cache memory is insufficient, it becomes difficult for the SSD apparatus to hold newly received data in the cache memory, which may make it difficult to write the data. In such a case, for example, an error message is output to the host which is the sender of the data to inform that it is not allowed to store the data. Thus, in this case, the host is not capable of writing the data in the SSD apparatus.

In an aspect of the embodiments, in a state in which a free storage area capable of continuously storing data is not yet achieved, it is possible to reduce the time spent to store the data in the storage device.

### SUMMARY

According to an aspect of the invention, a method of controlling a storage device including a storage unit, comprises receiving a plurality of pieces of divided data which is generated by dividing first data according to data length information indicating a data length determined based on writing units in which data is to be written in a storage unit and which is assigned number information identifying an order of locations in the first data to each of the pieces of divided data, storing the plurality of pieces of received divided data in a free storage area capable of storing the data in the storage unit, reading out the plurality of pieces of stored divided data from the storage unit and storing the read plurality of pieces of divided data into a continuous free storage area in the storage unit in an order indicated by the number information.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates a system according to an embodiment.

FIG. 2 is a functional block diagram of a control apparatus.

FIG. 3 is a functional block diagram of an SSD apparatus.

FIG. 4 is a flow chart illustrating a process performed by a control apparatus when the control apparatus receives data from a host.

FIG. 5 illustrates an example of a data structure of data received by a host-side transmitting/receiving unit.

FIG. 6 illustrates a state of a block of a data storage unit.

FIG. 7 is a flow chart illustrating a process performed by an SSD apparatus to store data based on a command given by a control apparatus.

FIG. 8 illustrates a state of a block.

FIG. 9 illustrates a specific example of the process illustrated in FIG. 7.

FIG. 10 illustrates a state in which data is stored in a block.

FIG. 11 illustrates a state in which data is stored in the block.

FIG. 12 illustrates an example of a bit map.

FIG. 13 is a flow chart illustrating a migration process.

FIG. 14 is a flow chart illustrating a detailed procedure of a migration process.

FIG. 15 illustrates a state obtained after a migration process is performed on data stored in a block.

FIG. 16 illustrates a first modification.

FIG. 17 illustrates a conventional example.

### DESCRIPTION OF EMBODIMENTS

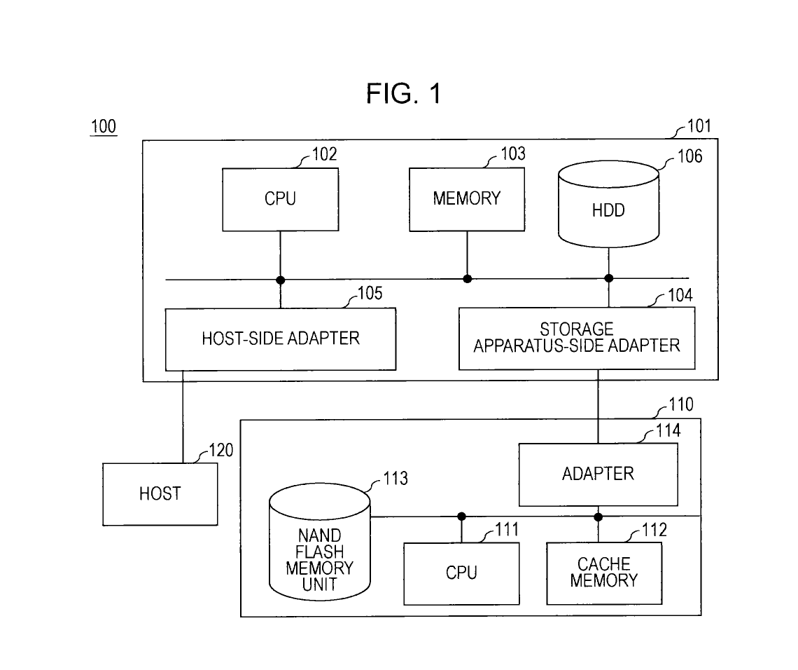

Embodiments are described below. FIG. 1 illustrates a system 100 according to an embodiment. As illustrated in FIG. 1, the system 100 includes, for example, an SSD apparatus 110 and a control apparatus 101 that controls the SSD apparatus 110.

As illustrated in FIG. 1, the control apparatus 101 includes a CPU (Central Processing Unit) 102, a memory 103, a storage apparatus-side adapter 104, and a host-side adapter 105, which are connected to each other via a bus such that they are allowed to communicate with each other.

The CPU 102 performs an operation process to control the SSD apparatus 110 in the system 100. The memory 103 stores information used in controlling the system 100. The memory 103 may store a program executed by the CPU 102.

The control apparatus 101 is connected to the SSD apparatus 110 via the storage apparatus-side adapter 104. The connection between the control apparatus 101 and the SSD apparatus 110 may be made via, for example, a SAN (Storage Area Network), fiber channel, or the like. Alternatively, SCSI (Small Computer System Interface) may be used to connect the control apparatus 101 to the SSD apparatus 110. The control apparatus 101 may be connected to a plurality of SSD apparatuses 110.

The control apparatus 101 is also connected to a host 120 via the host-side adapter 105. For the connection between the control apparatus 101 and the host 120, for example, iSCSI (Internet SCSI) may be used. The host 120 is an information processing apparatus such as a server apparatus, a PC (Personal Computer), or the like that issues a data write request or a data read request to the SSD apparatus 110.

The SSD apparatus 110 may store data, for example, in response to a request from the host 120. The SSD apparatus 110 is a storage device including, for example, as illustrated in FIG. 1, a CPU 111, a cache memory 112, a NAND flash memory 113, and an adapter 114, which are connected to each other via a bus so as to allow mutual communication.

The CPU 111 performs an operation process to control the SSD apparatus 110. The cache memory 112 may be used to store a copy of data stored in the NAND flash memory 113. The cache memory 112 may also be used to store information used in controlling the storage device 110. The NAND flash memory 113 includes a data storage area accessible by the control apparatus 101. The SSD apparatus 110 may store data in the NAND flash memory 113 in response to a request issued by the host 120. The SSD apparatus 110 is connected to the control apparatus 101 via the adapter 114. In the present embodiment, it is assumed by way of example that the data storage device is the SSD apparatus 110. Note that an HDD (Hard Disk Drive) or the like may be used instead of the SSD apparatus.

Description of Functional Blocks

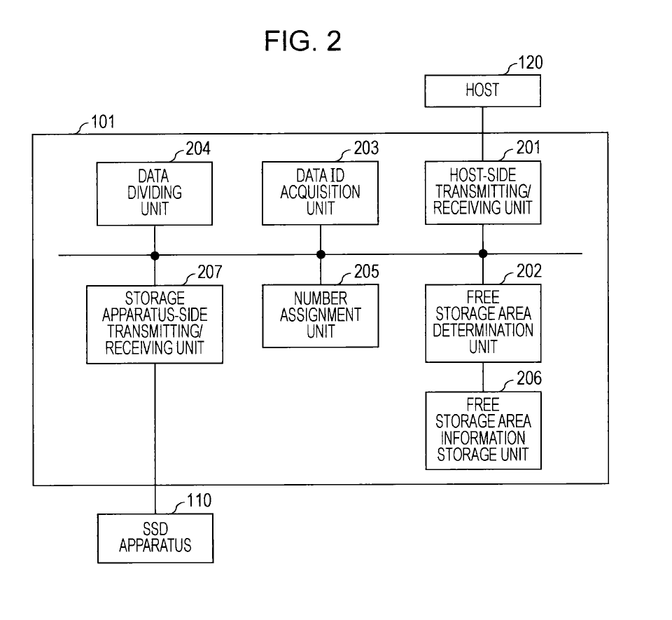

FIG. 2 is a functional block diagram of the control apparatus 101. The control apparatus 101 includes, as functional units, a host-side transmitting/receiving unit 201, a free storage area determination unit 202, a data ID acquisition unit 203, a data dividing unit 204, a number assignment unit 205, a free storage area information storage unit 206, and a storage apparatus-side transmitting/receiving unit 207.

The host-side transmitting/receiving unit 201 receives, from the host 120, a command and data to be written in the SSD apparatus 110, and the host-side transmitting/receiving unit 201 transmits a response based on the command to the host 120. The free storage area determination unit 202 determines whether the SSD apparatus 110 has a free storage area available for storing the data received by the host-side transmitting/receiving unit 201. The data ID acquisition unit 203 acquires an identifier, which is to be also used as a data ID, from the data received by the host-side transmitting/receiving unit 201. The data dividing unit 204 generates divided data by dividing the data received by the host-side transmitting/receiving unit 201 for every predetermined data length. The number assignment unit 205 assigns a data ID and an intra-data number to each divided data generated by the data dividing unit 204. The free storage area information storage unit 206 stores information indicating the sum of data lengths of the free storage areas available in the SSD apparatus 110. The storage apparatus-side transmitting/receiving unit 207 transmits, to the SSD apparatus 110, the divided data to which the data ID and the identification number (intra-data number) identifying the order of data assigned by thy number assignment unit 205.

The free storage area determination unit 202, the data ID acquisition unit 203, the data dividing unit 204, and the number assignment unit 205, described above, may be realized, for example, by executing a program stored in the memory 102 by the CPU 101. The host-side transmitting/receiving unit 201 and the storage apparatus-side transmitting/receiving unit 207 may be respectively realized, for example, by using the host-side adapter 105 and the storage apparatus-side adapter 104 illustrated in FIG. 1. The free storage area information storage unit 206 may be realized, for example, by using the memory 103 illustrated in FIG. 1.

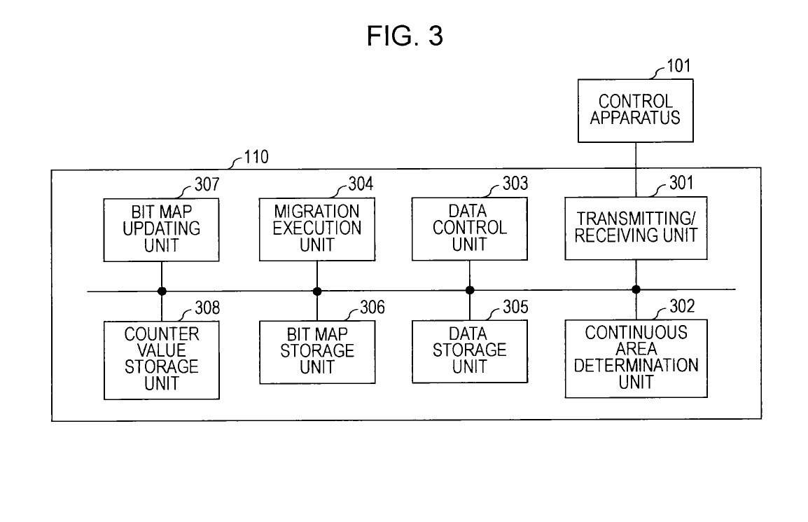

FIG. 3 is a functional block diagram of the SSD apparatus 110. The SSD apparatus 110 includes, as functional units, a transmitting/receiving unit 301, a continuous free area determination unit 302, a data control unit 303, a migration execution unit 304, a data storage unit 305, a bit map storage unit 306, a bit map updating unit 307, and a counter value storage unit 308.

The transmitting/receiving unit 301 receives the divided data transmitted by the control apparatus 101, and the transmitting/receiving unit 301 transmits a response based on reading/writing of data to the control apparatus 101. The continuous free area determination unit 302 determines whether the data storage unit 305 has a continuous free storage area available for storing the divided data received by the transmitting/receiving unit 301. The data control unit 303 writes the divided data in the data storage unit 305. The data control unit 303 also reads out the data stored in the data storage unit 305 in response to a request from the host. The data control unit 303 is an example of a first storage control unit and a readout unit. The migration execution unit 304 executes a process (migration) to rearrange the data written in the data storage unit 305. The migration execution unit 304 is an example of a second storage control unit. The data storage unit 305 includes a storage area (block) in which data is stored based on a command given by the host. The bit map storage unit 306 stores information (bit map) indicating data stored in each block of the data storage unit 305. In accordance with an operation of the SSD apparatus 110, the bit map updating unit 307 updates the information stored in the bit map storage unit 306. The counter value storage unit 308 stores the number of pieces of data to be subjected to the migration. The transmitting/receiving unit 301 and other units 302 to 307 described above may be realized, for example, by the CPU 111 by executing a program stored in the cache memory 112. The data storage unit 305 may be realized, for example, by using the cache memory 112 or the data storage unit 305. The bit map storage unit 306 and the counter value storage unit 308 may be realized, for example, by using the cache memory 112. The operations of the respective functional units will be described in further detail later.

Assigning Identification Information

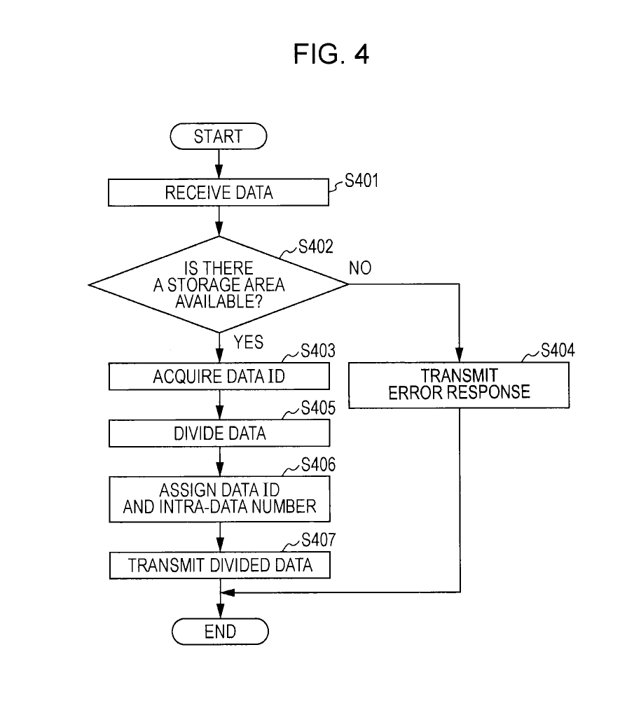

A procedure is described below in terms of a process performed by the control apparatus 101 on data received from the host 120. FIG. 4 is a flow chart illustrating the process performed by the control apparatus 101 when the control apparatus 101 receives data from the host 120.

First, from the host 120, the host-side transmitting/receiving unit 201 receives a command and data to be written in the SSD apparatus 110 (S401).

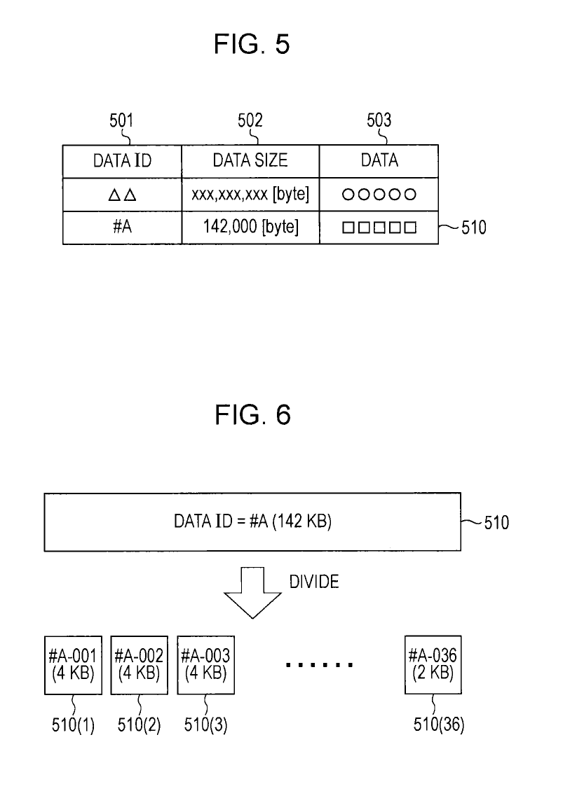

FIG. 5 illustrates an example of a data structure of data received by the host-side transmitting/receiving unit 201. The data structure 500 illustrated in FIG. 5 includes a data ID (Identifier) 501, a data size 502, and data 503. The data ID 501 is an identifier that identifies the data. The identifier is an example of identification information. The data size 502 is information indicating the data length of the data 503. The data 503 is a main part of the data transmitted by the host 120. An example of data 503 is a data file produced by a user using the host 120.

Referring to FIG. 4 illustrating the process, the free storage area determination unit 202 determines whether the data storage unit 305 of the SSD apparatus 110 has a free storage area available for storing the data received by the host-side transmitting/receiving unit 201 (S402). For example, the determination may be made such that the free storage area determination unit 202 refers to the information of the data size 502 on the received data and compares the sum of data sizes of free storage areas available in the data storage unit 305 with the information of the data size 502. The sum of data sizes of free storage areas available in the data storage unit 305 may be acquired, for example, such that information indicating the sum of data lengths of free storage areas available in the data storage unit 305 is stored in the free storage area information storage unit 206 of the control apparatus 101, and the free storage area determination unit 202 acquires the sum of data sizes of free storage areas from the free storage area information storage unit 206. In a case where it is determined that there is no free storage area available for the current purpose, the host-side transmitting/receiving unit 201 transmits a response (an error response in FIG. 4) to the host 120 to notify that no free storage area is available in the SSD apparatus 110 (S404). Thereafter, the process is ended.

On the other hand, in a case where it is determined that a free storage area for the current purpose is available in the data storage unit 305, the data ID acquisition unit 203 acquires the data ID of the received data. The data ID for the present purpose may be given, for example, by acquiring the data ID 501 illustrated in FIG. 5. In a case where the data received from the host does not include the data ID 501 or information usable as the data ID, the control apparatus 101 may generate data IDs uniquely assigned to respective pieces of data when the control apparatus 101 receives the data.

After the acquisition of the data ID, the data dividing unit 204 divides the received data 503 for each predetermined data length (S405). The predetermined data length is, for example, a unit of writing data length according to which data writhing is performed by the SSD apparatus 110. In the present embodiment, it is assumed by way of example that the unit of writing data length defined for the SSD apparatus 110 is 4 kbytes, and thus the data dividing unit 204 divides the received data 503 for every 4 kbytes. Hereinafter, this writing unit will be also referred to as a page. Note that in the present embodiment, the data size of one page is set, by way of example, to 4 kbytes to adapt to specifications in terms of controlling the SSD apparatus, and the setting may be changed depending on specifications of the SSD apparatus 110 or other factors. Hereinafter, data obtained as a result of the dividing process described above will referred to as divided data.

After the data is divided by the data dividing unit 204, the number assignment unit 205 assigns, to each piece of divided data, the data ID acquired by the data ID acquisition unit 203 in step S403 and an intra-data number (S406). The intra-data numbers are, for example, serial numbers assigned to respective pieces of divided data in serial order starting from data at a starting location. The data ID and the intra-data number may be stored, for example, in a redundant byte (redundant storage area) of each piece of divided data thereby assigning the data ID and the intra-data number.

After the number assignment unit 205 assigns the data ID and the intra-data numbers to the respective pieces of divided data, the storage apparatus-side transmitting/receiving unit 207 transmits the respective pieces of divided data to the data storage unit 305 of the SSD apparatus 110 (S407). Thus, the process in the control unit 101 is complete.

The process described above with reference to FIG. 4 is explained in further detail below for a particular example of data.

For example, when data 510 with the data structure illustrated in FIG. 5 is received by the host-side transmitting/receiving unit 201 (S401), the free storage area determination unit 202 determines whether the data storage unit 305 of the SSD apparatus 110 has a free storage area available for storing the data 510 (S402). As illustrated in FIG. 5, the data 510 has a data length of 142 kbytes (hereinafter referred to as KB). In this example, it is assumed that the data storage unit 305 has a free storage area available for storing the data 510, that is, the data storage unit 305 has a free storage area with a data length equal to or greater than 142 KB.

When the free storage area determination unit 202 determines that the data storage unit 305 has a free storage area available for storing the data 510, the data ID acquisition unit 203 acquires a data ID included in the data 510 (S403). In this example, as illustrated in FIG. 5, the data 510 includes data ID=#A, and thus the data ID acquisition unit 203 acquires data ID=#A.

After the data ID is acquired, the data dividing unit 204 divides the data 510 into pages each of which has a size of 4 KB in the present example (S405). Thus, the data 510 with a data length of 142 KB is divided into 36 pieces of data 510(1) to 510(36) as illustrated in FIG. 6. The number assignment unit 205 assigns #A as data ID and numbers from 001 to 036 as intra-data numbers to the respective pieces of divided data (S406). The data ID and the intra-data numbers may be stored, for example, in redundant bits, i.e., redundant storage areas provided in the respective pages. In a case where the data size is not equal to a multiple of 4 KB as in the present example, then, for example, a last piece of divided data 510(36) at an end location may have a data size less than 4 KB as illustrated in FIG. 6. The number assignment unit 205 may set information (a last data flag) in the last piece of divided data at the end location (the divided data 510(36) in the current example) to indicate that the data is the last data at the end location. The last data flag may be stored in a redundant bit, i.e., a redundant storage area provided in each page as with the data ID and the intra-data number.

After the process in step S406 is complete, the storage apparatus-side transmitting/receiving unit 207 transmits data 510(1) to 510(36) to the SSD apparatus 110 (S407). Thus, the process in the control apparatus 101 is complete.

Via the process in steps S401 to S407 described above, the control apparatus 101 generates divided data by dividing data received from the host 120 into pages, and then assigns data ID and intra-data numbers to respective pieces of divided data, and finally transmits the divided data to the SSD apparatus 110. Note that the procedure of the process illustrated in FIG. 4 is an example, and the process may be performed according to other procedures. Furthermore, the data IDs and the intra-data numbers illustrated in FIG. 6 are examples, and the data IDs and the intra-data numbers may be given in other formats.

Operation of SSD Apparatus

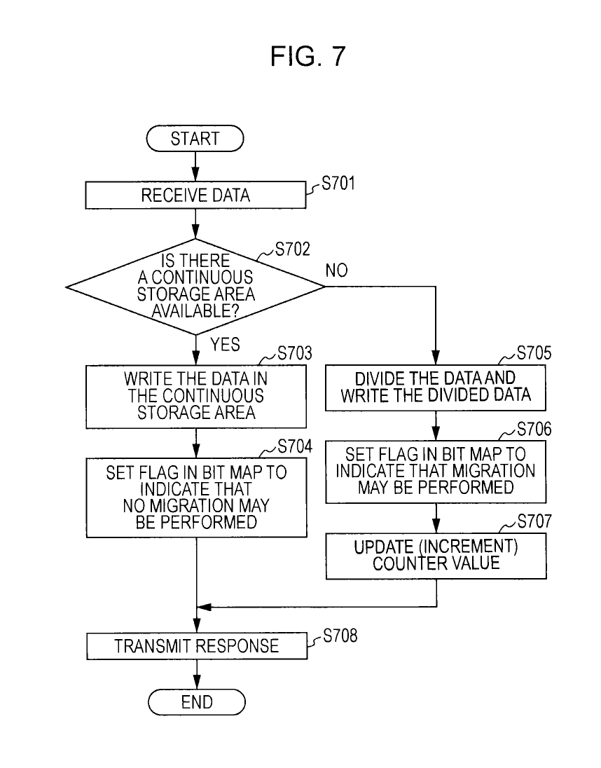

A procedure is described below as to a process performed by the SSD apparatus 110 to store the divided data generated by the control apparatus 101. FIG. 7 is a flow chart illustrating the procedure of the process performed by the SSD apparatus 110 to store received data in response to receiving the data from the control apparatus 101.

First, the transmitting/receiving unit 301 receives the divided data transmitted from the control apparatus 101 (S701).

Next, the continuous free area determination unit 302 determines whether the data storage unit 305 has a continuous free storage area available for storing the divided data (S702). A specific example of a determination method is to use a bit map stored in the bit map storage unit 306 to determine whether a continuous free storage area is available. The details of the specific determination method will be described later.

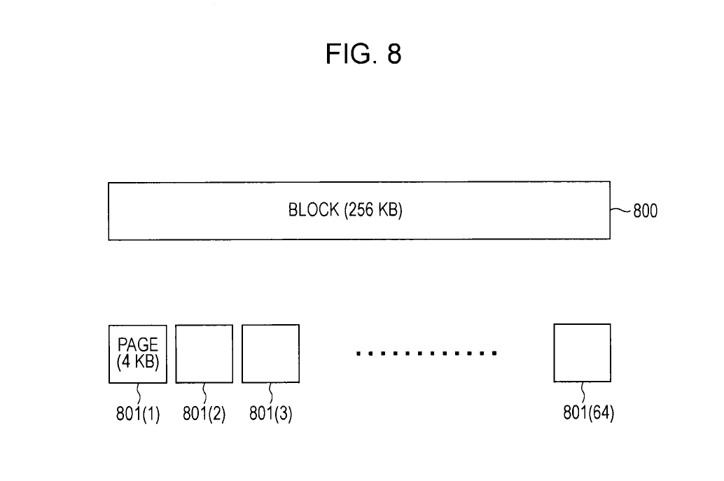

Before the process in step S702 is described, an explanation is given as to a configuration in terms of storage areas of the data storage unit 305 of the SSD apparatus 110. FIG. 8 illustrates an example of a configuration of the data storage unit 305 of the SSD apparatus 110 according to the present embodiment.

In the present embodiment, the storage area of the data storage unit 305 is divided into sub storage areas each having a size of 256 KB. Hereinafter, these sub data storage areas will be referred to as blocks. FIG. 8 illustrates a block 800 as an example of a block in the storage area of the data storage unit 305. An explanation is given below as to why the storage area is divided into blocks. In the SSD apparatus, when data is deleted, it may not be allowed to delete the data in units of bits or pages, but it may be allowed to delete the data in units of grater data lengths depending on the specifications. In such a case, the SSD apparatus manages stored data in units of groups of pages in which data are deleted at a time. The blocks in the present embodiment correspond to the groups of pages that are units in which data is deleted at a time. Furthermore, each block is divided into sub blocks, corresponding to the pages described above, each having a size of 4 KB.

Referring again to FIG. 7, in step S702, the continuous free area determination unit 302 determines whether the block 800 has a continuous free storage area available for storing the data received in step S701. In a case where the continuous free area determination unit 302 determines that there is a free storage area available for storing the data, a process in step S703 is performed. On the other hand, in a case where there is no free storage area available for storing the data, a process in step S705 is performed.

A description is given below as to the process performed when the continuous free area determination unit 302 determines in step S702 that the data storage unit 305 has a continuous free storage area available for storing the data. In this case, the data control unit 303 stores the divided data in the continuous free storage area of the data storage unit 305 successively in order of intra-data numbers (S703). The bit map updating unit 307 sets a flag (migration flag) in the bit map corresponding to the stored data so as to indicate that migration is not to be performed (S704). After the process in step S703 is complete, the transmitting/receiving unit 301 transmits a response to the control apparatus 101 to notify that the process for the received divided data is complete (S708). Thereafter, the process is ended.

Next, a description is given below as to the process performed when the continuous free area determination unit 302 determines in step S702 that the data storage unit 305 does not have a continuous free storage area available for storing the data. In this case, depending on data lengths of free storage areas, the data storage unit 305 stores the divided data separately in free storage areas of the data storage unit 305 (S705).

The bit map updating unit 307 sets a flag (migration flag) in the bit map corresponding to the stored divided data so as to indicate that migration is to be performed (S706). The bit map updating unit 307 updates the counter value stored in the counter value storage unit 308 (S707). The counter value is described below. In the present embodiment, the counter value is information indicating the number of pieces of data (before subjected to the dividing process) that are included in data stored in the data storage unit 305 and that are to be subjected to migration. The bit map updating unit 307 manages whether migration is to be performed and how many pieces of data are to be subjected to migration such that each time a migration flag is set in a bit map corresponding to a piece of stored data so as to indicate that the data is to be subjected to migration, the bit map updating unit 307 increments the counter value stored in the counter value storage unit 308. For example, if the current counter value stored in the counter value storage unit 308 is equal to “0”, then this means that the data stored in the data storage unit 305 includes no data that is to be subjected to migration. On the other hand, if the current counter value stored in the counter value storage unit 308 is equal to, for example, “3”, then this means that the data stored in the data storage unit 305 includes three pieces of data to be subjected to migration.

After the process in step S707 is complete, the transmitting/receiving unit 301 transmits a response to the control apparatus 101 to inform that the process of storing the divided data in the data storage unit 305 is complete (S708). Thereafter, the process is ended.

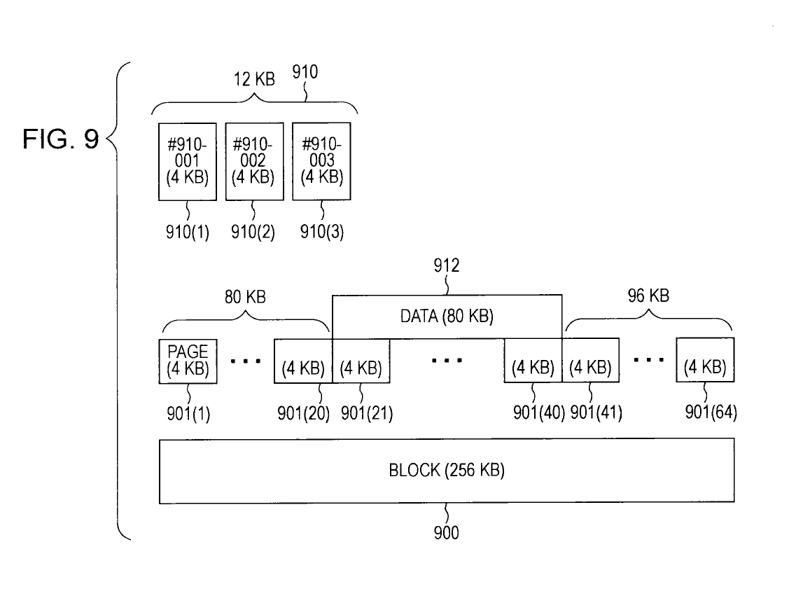

The process illustrated in FIG. 7 is described in further detail with reference to an example of data. FIG. 9 illustrates a specific example of the process illustrated in FIG. 7. In the example illustrated in FIG. 9, a process is performed by the SSD apparatus 110 to store data 910 and data 911 in a block 900.

In FIG. 9, the data 910 has a data length of 12 KB. In the present embodiment, as described above, at a point of time at which the SSD apparatus 110 receives data, the data has been divided in units of 4 KB via the process performed by the control apparatus 101, and a data ID and an intra-data number have been assigned to each piece of divided data. Thus, as illustrated in FIG. 9, the data 910 is in a state in which the data 910 has been divided into pieces of data, i.e., divided data 910(1) to 910(3), and a data ID and an intra-data number have been assigned to each piece of divided data.

The block 900 is a storage area capable, as a whole, of storing data of up to 256 KB, and the block 900 includes pages 901(1) to 901(64) each having a size of 4 KB. In the example illustrated in FIG. 9, data 912 with a data length of 80 KB has already been stored in pages 901(21) to 901(40). At this point of time, pages 901(1) to 901(20) and pages 901(41) to 901(64) are free storage areas in which no data is stored. Although not illustrated in FIG. 9, it is assumed that data is already stored in pages of a block adjacent to the block 900.

First, an explanation is given below as to a process of storing the data 910 in the block 900.

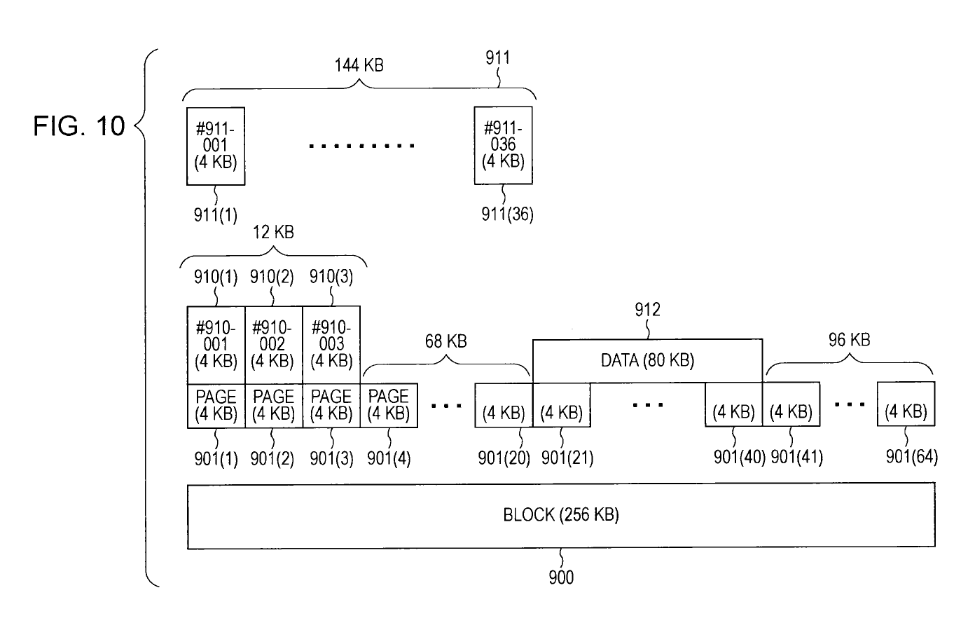

First, the continuous free area determination unit 302 determines whether the block 900 has an area available for continuously storing the data 910 (S701). In this specific case, the block 900 has an area available for storing the data 910 with the data length of 12 KB (for example, pages 901(1) to 901(3) are usable for this purpose). Thus, the data storage unit 305 stores the data 901 in a free storage area of the block 900 successively in order of intra-data numbers (S703). The bit map updating unit 307 sets a migration flag in a bit map, corresponding to each page in which divided data of the data 910 is stored, so as to indicate that migration is not to be performed (S704). After the process in step S703 is complete, the transmitting/receiving unit 301 transmits a response to the control apparatus 101 to notify that the process of storing the data 910 is complete (S708). Thereafter, the process is ended. As a result, the data 910 is stored in the block 900 in a manner, for example, as illustrated in FIG. 10. FIG. 10 illustrates a state of the block 900 after the above-described process is performed by the SSD apparatus 110. As illustrated in FIG. 10, the divided data 911(1) to 911(3) of the data 910 are stored in pages 901(1) to 901(3), which were free areas before, in the block 900.

Next, an explanation is given below as to a process of storing data 911 in the block 900 when the block 900 is in the state illustrated in FIG. 10. The data 911 has a data length of 144 KB. As with the data 910, the data 911 has already been divided in divided data 911(1) to 911(36) via a process performed by the control apparatus 101. First, the continuous free area determination unit 302 determines whether the block 900 has an area available for continuously storing the data 911 (S701). In this specific case, the block 900 does not have a continuous area capable of storing the data 911 with the data length of 144 KB. That is, in the state illustrated in FIG. 10, a greatest continuous data length in the block 900 is 68 KB, which is shorter than the data length of 144 KB of the data 911. Therefore, the continuous free area determination unit 302 determines that the block 900 does not have an area capable of continuously storing the data 911, and thus the data storage unit 305 performs a process in step S705.

In step S705, the data storage unit 305 stores the data 911 into the block 900 after dividing the data 911 into a plurality of pieces of data.

For example, the process in step S705 may be performed as follows. Pages 901(4) to 901(20) have, as a whole, a data length of 68 KB, and thus these pages 901(4) to 901(20) are used to store data of 68 KB in a begging part of the data 911, i.e., divided data 911(1) to 911(17). Pages 901(41) to 901(59) have, as a whole, a data length of 76 KB, and thus these pages 901(41) to 901(59) are used to store the remaining part of the data 911, i.e., divided data 911(18) to 911(36) which are 76 KB in total data length.

After the data 911 is stored, the bit map updating unit 307 sets a migration flag in a bit map corresponding to each page in which divided data of the data 911 is stored so as to indicate that the data in the page is to be subjected to migration (S706). Thereafter, the bit map updating unit 307 increments the counter value stored in the counter value storage unit 308 (S707). For example, if the current counter value stored in the counter value storage unit 308 is equal to “0”, the bit map updating unit 307 increments the counter value to “1” such that the counter value indicates that the data stored in the data storage unit 305 includes one piece of data that is to be subjected to migration.

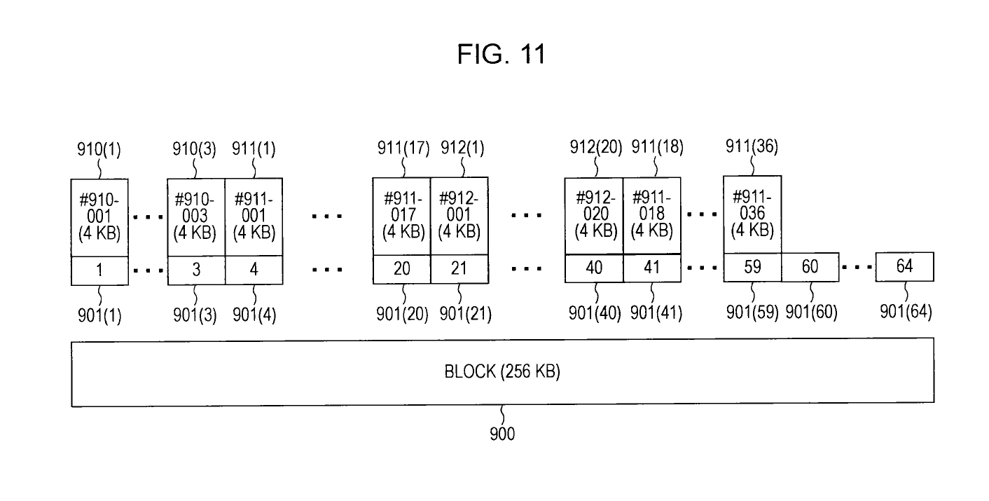

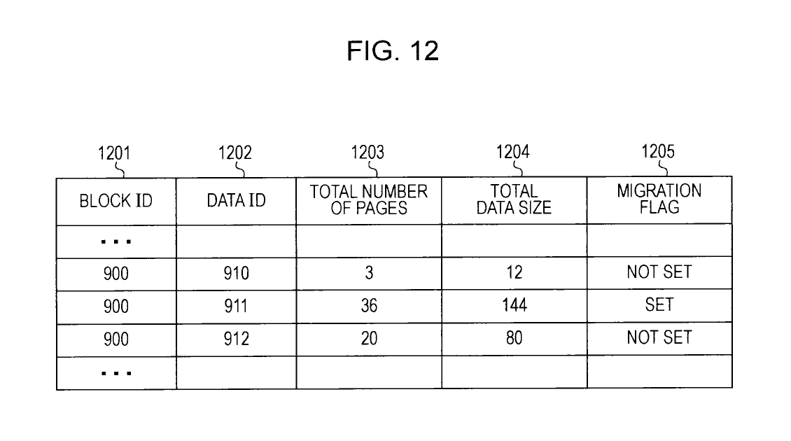

FIG. 11 illustrates a state achieved as a result of storing the data 910, 911, and 912 in the block 900 via the process described above. That is, by storing data in the block 900 as illustrated in FIG. 11, the block 900 goes into the state in which the data 910, 911, and 912 are stored in the manner illustrated in FIG. 11. Note that in FIG. 11, pages 901(60) to 901(64) are free storage areas in which no data is stored. In the example illustrated in FIG. 11, data is stored in the block 900 starting from the page 901(1) in order the data 910, the data 912, and the data 911. However, according to the present embodiment, it is allowed to identify the respective pieces of divided data by the data ID and the intra-data numbers. Therefore, it may be allowed to store the data in an order different from that illustrated in FIG. 11. For example, the data may be stored in the order the data 911, the data 912, and the data 910. FIG. 12 is a table illustrating a bit map for a case in which the data storage unit 305 is in the state illustrated in FIG. 11. The bit map includes, for example, as illustrated in FIG. 12, a block ID column 1201 in which the block ID of data stored in the block 900 is described, a data ID column 1202, a column 1203 for describing the total number of pages, a total data length column 1204, and a migration flag column 1205.

The block ID is an identifier identifying each block in the data storage unit 305. In FIG. 12, the block ID identifying the block 900 is described as “900”. Alternatively, the block ID may be described in other formats such as a hexadecimal format. The data ID 1202 may be identical to the data ID described above.

The total number of pages 1203 is information indicating the total number of pages of data in each block. As for the total data length 1204, a data size 502 included in data received from the host may be used. The migration flag 1205 is information defined in step S706 by the bit map updating unit 307 to indicate whether migration is to be performed or not. In FIG. 12, for convenience of illustration, “ON” is used to describe a state in which migration is to be performed, and “OFF” is used to describe a state in which migration is not to be performed. Alternatively, for example, “1” or “true” may be used to describe a state in which migration is to be performed, and “0” or “false” may be used to describe a state in which migration is not to be performed. Conversely, “0” or “false” may be used to describe a state in which migration is to be performed, and “1” or “true” may be used to describe a state in which migration is not to be performed.

When data stored in the data storage unit 305 is read out, the data control unit 303 is allowed to identify divided data and the order of the divided data based on data IDs and intra-data numbers. Therefore, even in a case where divided data is not stored in successive pages in a block, for example, as with the data 911(1) to 911(36) illustrated in FIG. 11, the data control unit 303 is capable of reading out data identifying divided data and the order of the divided data based on data IDs and intra-data numbers. Also even in a case where divided data is not stored according to the order of intra-data numbers in a block, the data control unit 303 is capable of reading out data identifying divided data and the order of the divided data based on data IDs and intra-data numbers. In such a case, the data control unit 303 may identify divided data based on data IDs and may identity the order of divided data based on intra-data numbers. The data control unit 303 may identify last divided data at an end location based on the state of a last data flag. Alternatively, identifying of last divided data located at the end may be performed based on a total data size 1204 included in a bit map.

Thus, via the process in steps S701 to S708, the data 910 and the data 911 are stored in the block 900 as illustrated in FIG. 11. Note that the data 911 is stored in areas at non-successive locations. However, as described above, the data control unit 303 is capable of identifying divided data and the order of the divided data based on the data ID and the intra-data numbers. Therefore, even in a case where data is not stored in successive pages in a block, the data control unit 303 is capable of properly reading the data. Thus, when the SSD apparatus 110 receives data, the SSD apparatus 110 may not perform a garbage collection process to obtain a continuous storage area. This makes it possible to reduce a time spent to store received data in the NAND flash memory 113 since the reception of the data from the host 120.

Migration Process

When data is divided and stored at non-successive storage locations, it may be possible to rearrange the order of storage locations into successive locations, which makes it possible to read out the data in a so-called sequential reading manner. Thus, it becomes possible to increase the reading speed at which the data control unit 303 reads out data.

Thus, the SSD apparatus 110 performs a process to re-store the split-apart data at successive locations in the storage area based on the intra-data numbers. In the present embodiment, this process is referred to as migration.

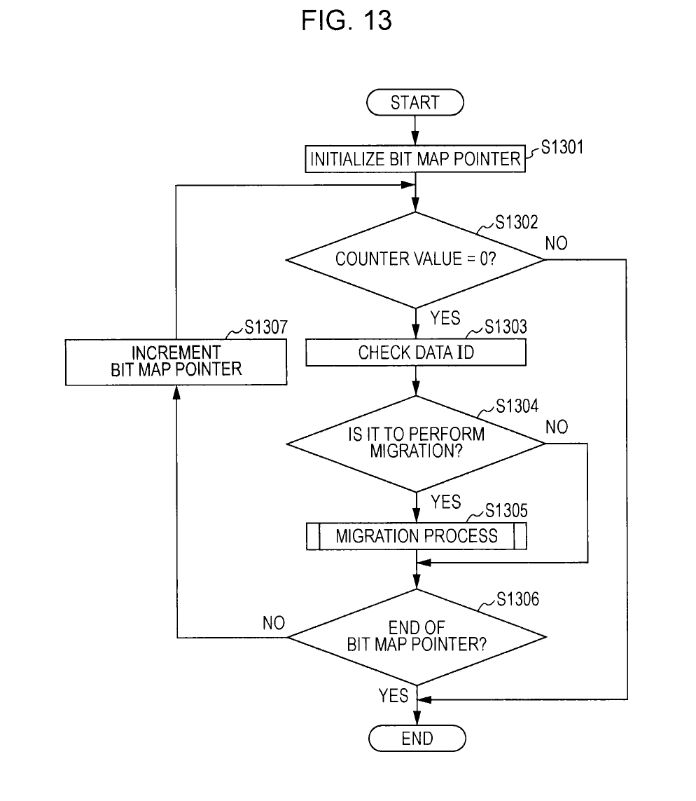

A procedure of the migration according to the present embodiment is described below. FIG. 13 is a flow chart illustrating the procedure of the migration process performed by the SSD apparatus 110 according to the present embodiment.

First, the migration execution unit 304 initializes a bit map pointer to a start point of the bit map (S1301). The bit map pointer is information indicating a location (for example, a row in a case where the bit map is given in a data table form such as that illustrated in FIG. 12) in the bit map referred to by the migration execution unit 304.

Next, the migration execution unit 304 determines whether the counter value stored in the counter value storage unit 308 is equal to 0 (S1302). When the counter value is equal to 0, the value indicates that there is no data to be subjected to migration. Therefore, the migration execution unit 304 ends the migration process illustrated in FIG. 13.

On the other hand, when it is determined in step S1302 that the counter value is not equal to 0 (i.e., the counter value is equal to an integer other than 0), the value indicates that the data storage unit 305 includes data that is to be subjected to migration. Therefore, the migration execution unit 304 performs a process in step S1303.

In step S1303, the migration execution unit 304 refers to a data ID and a migration flag corresponding to a current value of the bit map pointer. The migration execution unit 304 checks whether the migration flag corresponding to the current value of the bit map pointer is set to “ON” or “OFF” thereby determining whether migration is to be performed or not to be performed (S1304). In a case where the flag is set to “OFF”, i.e., the flag indicates that migration is not to be performed, the migration execution unit 304 performs a process in step S1306.

On the other hand, in a case where the flag is set to “ON”, i.e., the flag indicates that migration is to be performed, the migration execution unit 304 performs a process in step S1305.

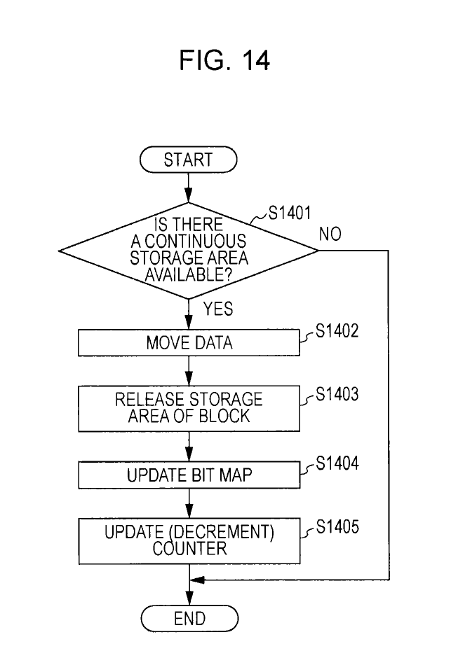

The migration process in step S1305 is described in further detail below. FIG. 14 is a flow chart illustrating the details of the procedure of the migration process in step S1305.

First, based on the bit map, the continuous free area determination unit 302 identifies a block in which divided data with an assigned ID identical to a data ID included in the current bit map point. The continuous free area determination unit 302 then determines whether the data storage unit 305 has a continuous free storage area capable of storing the data of the identified block (S1401).

In a case where the continuous free area determination unit 302 determines that there is no continuous free storage area available for migration of the data, the process in step S1305 is ended without performing the migration process on the data.

On the other hand, in a case where the continuous free area determination unit 302 determines that there is a continuous free storage area available for the migration, a process is performed to move the data into the continuous free storage area (S1402). This process is described in further detail below. First, the migration execution unit 304 copies the divided data included in the identified block into the cache memory 112. The migration execution unit 304 then rearranges the divided data copied in the cache memory 112. In the rearrangement, the migration execution unit 304 may identify divided data based on a data ID and may identity an order of divided data based on intra-data numbers. The migration execution unit 304 may identify divided data at an end location based on the state of a last data flag. Alternatively, identifying of divided data located at the end may be performed based on a total data size 1203 included in a bit map.

After the data copied in the cache memory 112 is rearranged, the migration execution unit 304 stores the rearranged divided data in the continuous free storage area. As described above, the migration execution unit 304 moves the divided data such that the moved data is stored at successive locations in the continuous free storage area in the order of the intra-data numbers.

After the data is moved in step S1402, the migration execution unit 304 deletes the data in the block identified in step S1402 thereby releasing the storage area in the block as a free storage area (S1403).

Alternatively, after the divided data is copied in the cache memory 112 and rearranged in step S1402, the migration execution unit 304 may delete the data in the identified block and then may store the divided data in this block.

After the process in step S1403 is complete, the bit map updating unit 307 updates the bit map according to the movement of data (S1404). More specifically, because the divided data is stored in the continuous free storage area, the bit map corresponding to the continuous free storage area is updated so as to indicate that the continuous free storage area is in a state in which the data is stored. Because the data stored in the continuous free storage area has been rearranged in the order based on the intra-data numbers, the migration flag is set to “OFF”. On the other hand, the block in which the divided data was originally stored is released as a free storage area, and thus the bit map is updated so as to indicate that this block is a free storage area.

After the bit map is updated, the migration execution unit 304 updates the counter value stored in the counter value storage unit 308. More specifically, because the migration process has been performed on the divided data that was set to be subjected to the migration process, and the data has been re-stored, the counter value is decremented by a value equal to the number of pieces of data for which the migration flag was in the “ON” state.

Thus, the migration process in step S1305 by the migration execution unit 304 is complete.

Referring again to FIG. 13, after the migration process in step S1305 is performed, the migration execution unit 304 determines whether the current value of the bit map pointer points to the last bit map point (S1306). Herein, the last bit map point refers to a point indicating a last block in the data storage unit 305 (for example, when the bit map is given in a data table form such as that illustrated in FIG. 12, a bottom row in the data table is pointed to). In a case where the migration execution unit 304 determines that the current value of the bit map pointer does not point to the last bit map point, the migration execution unit 304 increments the value of the bit map pointer (S1307), and repeats the process from step S1302. On the other hand, in step S1306, in a case where the migration execution unit 304 determines that the current value of the bit map pointer points to the last bit map point, the migration execution unit 304 ends the migration process illustrated in FIG. 13.

Thus, via the procedure described above, the data stored at split-apart locations in the data storage unit 305 of the SSD apparatus 110 is subjected to the migration process to rearrange the data locations such that it becomes possible to read out the data at a higher speed in response to a command issued by the host 120.

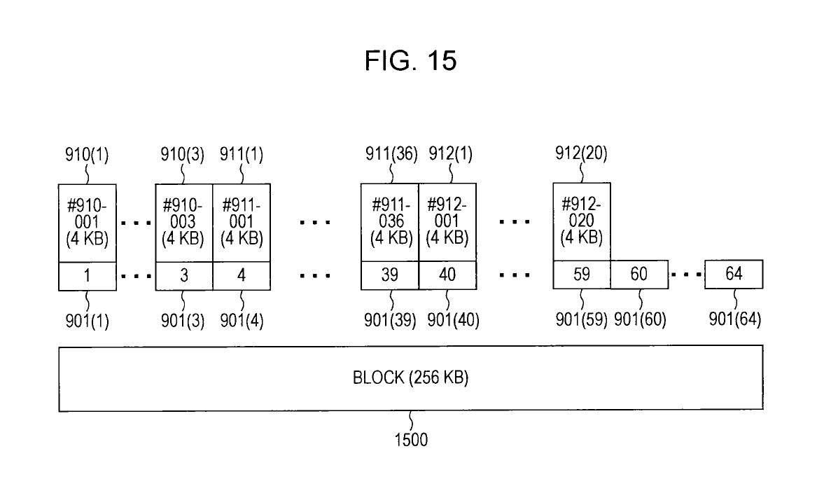

FIG. 15 illustrates a state obtained after the migration process illustrated in FIG. 13 is performed by the migration execution unit 304 on the data 910 to 912 stored in the block 900 as illustrated in FIG. 11. As a result of the migration process performed by the migration execution unit 304, the data 910 to 912 have been moved into a block 1500 different from the block 900 as illustrated in FIG. 15. In particular, the data 911(1) to 911(36) stored at split-apart locations in the block 900 are now at successive locations in the order of intra-data numbers in the block 1500. Therefore, when data is read out, for example, in response to a command issued by the host 120, it is possible to read out the data in a sequential manner. Note that at the point of time at which the data 910 and the data 911 are received, the block 1500 is not a free storage area, but the block 1500 is converted into a free storage area via a garbage collection process performed by the SSD apparatus 110 after the data 910 and the data 911 are stored in the block 900.

The garbage collection process according to a conventional technique may be performed by the SSD apparatus 110 in parallel to the above-described process according to the present embodiment to obtain a free storage area by properly moving data.

In the above description, it is assumed by way of example that data stored in the storage unit has a data length capable of being stored in one block. Note that the process may be performed in a similar manner according to the embodiment also for a case in which data is stored over a plurality of blocks (for example, in a case where received data has a data length greater than 256 KB). In such a case, the process may be performed based on bit map points stored in the bit map storage unit 306, corresponding to the blocks in which the data of interest is stored.

First Modification

According to the embodiment described above, data received from the host 120 is divided by the control apparatus 101, and a data ID and an intra-data number are assigned to each piece of divided data. For example, in a case where the control apparatus 101 includes the migration execution unit 304 and is capable of referring to the data ID and the intra-data numbers from the data stored in the SSD apparatus 110, the control apparatus 101 may perform the migration process based on the data ID and the intra-data numbers.

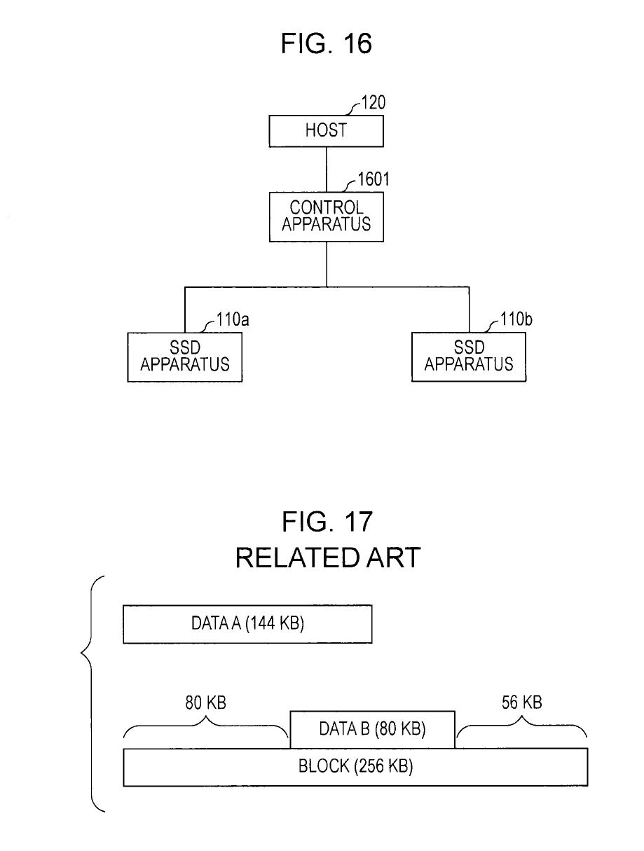

FIG. 16 illustrates a first modification to the embodiment described above. In the first modification, as illustrated in FIG. 16, a plurality of SSD apparatuses (two SSD apparatuses 110a and 110b in the example illustrating in FIG. 16) are connected to one control apparatus 1601. Note that it is assumed that the control apparatus 1601 illustrated in FIG. 16 is similar to that illustrated in FIG. 1 or FIG. 2 except that the control apparatus 1601 has a function of performing a migration process similar to that executed by the migration execution unit 304. The SSD apparatuses 110a and 110b illustrated in FIG. 16 each may be similar to the SSD apparatus 110 according to the embodiment described above. Hereinafter, the configuration illustrated in FIG. 16 will be referred to as the configuration according to the first modification. In the first modification, as in the configuration illustrated in FIG. 1, a host 120 is connected to the control apparatus 1601. Even in a case where a continuous free storage area capable of storing data transmitted from the host 120 to the control apparatus 1601 is not found in any one of the SSD apparatuses 110a and 110b, if a combination of storage areas of the two SSD apparatuses 110a and 110b provides free storage areas capable of storing the data, the data may be divided and the divided data may be stored separately in the two SSD apparatuses 110a and 110b. Thereafter, when a continuous free storage area capable of storing the data is obtained in one of the SSD apparatuses 110a and 110b, the data may be migrated into the obtained continuous free storage area. In this process, even when data is divided and stored separately in a plurality of SSD apparatuses, the control apparatus 1601 is capable of identifying the divided data and an order of the divided data based on a data ID and intra-data numbers. Therefore, the process of storing data and the migration process according to the embodiment described above may also be performed for a case in which data is divided and stored separately in a plurality of SSD apparatuses. This makes it possible to extend the functions and improve the performance of the SSD apparatuses.

The configurations employed in the embodiments described above are merely examples, and other configurations may be employed. For example, the system 100 according to the embodiment described above includes the control apparatus 101 and the SSD apparatus 110. Alternatively, the system 100 may be realized by a single piece of hardware having the functions of the control apparatus 101 and the SSD apparatus 110.

In the embodiments, modifications may be made, for example, in terms of procedures of processes. Many other modifications may be possible to the embodiments described above. For example, in the migration process illustrated in FIG. 14, migration is performed on data according to an order described in a bit map. Alternatively, data to be subjected to migration may be managed and processed using a cue. Information may be assigned in terms of a time at which data is received, priority of the data, etc., and, based on this information, the order of data may be controlled in migration.

The programs, which are executed by CPU, are able to be stored in a computer-readable non-transitory medium.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A control method of controlling a storage device including a storage unit, comprising:
receiving a plurality of pieces of divided data which is generated by dividing first data according to data length information indicating a data length determined based on writing units in which data is to be written in a storage unit and which is assigned number information identifying an order of locations in the first data to each of the pieces of divided data;
storing the plurality of pieces of received divided data in a free storage area capable of storing the data in the storage unit;
reading out the plurality of pieces of stored divided data from the storage unit; and
storing the read plurality of pieces of divided data into a continuous free storage area in the storage unit in an order indicated by the number information.

2. The control method according to claim 1, further comprising:
determining whether the storage unit has a free storage area capable of storing the plurality of pieces of divided data; and
storing the plurality of pieces of the divided data in the storage unit in a case where the determination is that there is a free storage area capable of storing the plurality of pieces of divided data.

3. The control method according to claim 1, further comprising:
determining whether a first storage unit in the storage unit has a free storage area capable of storing the plurality of pieces of divided data; and
storing part of the plurality of pieces of divided data in the first storage unit and storing the other remaining pieces of divided data in a second storage unit in the storage unit, the part being determined based on the free storage area of the storage unit, in a case where the determination is that the first storage unit has no free storage area capable of storing the plurality of pieces of divided data.

4. The control method according to claim 1, wherein the number information is stored in a redundant storage area of each of the pieces of divided data.

5. The control method according to of claim 1, wherein each of the plurality of divided data is assigned identification information identifying the first data; and
wherein the operation further comprises reading out the plurality of pieces of divided data having the same identification information from the storage unit.

6. A control method of controlling a storage device including a storage unit, comprising:
dividing first data into a plurality of pieces of divided data according to data length information indicating a data length defined based on writing units in which data is to be written in the storage unit;
assigning number information identifying an order of locations in the first data to each of the pieces of divided data;
storing the plurality of pieces of divided data assigned the number information in a free storage area in the storage unit capable of storing the plurality of pieces of divided data;
reading out the stored plurality of pieces of divided data from the storage unit; and
storing the read plurality of pieces of divided data in a continuous free storage area in the storage unit in an order indicated by the number information.

7. A storage device comprising:
a storage unit;
a dividing unit configured to divide received data into a plurality of pieces of divided data according to data length information indicating a data length defined based on writing units in which data is to be written in the storage unit;
an assignment unit configured to assign number information identifying an order of locations in the received data to each of the pieces of divided data;
a first storage control unit configured to store the plurality of pieces of divided data assigned the number information in a free storage area in the storage unit capable of storing the plurality of pieces of divided data;
a readout unit configured to read out the plurality of pieces of stored divided data from the storage unit; and
a second storage control unit configured to store the read plurality of pieces of divided data in a continuous free storage area in the storage unit in an order indicated by the number information.

8. The storage device according to claim 7, further comprising:
determining unit configured to determine whether the storage unit has a free storage area capable of storing the plurality of pieces of divided data; and
storing the plurality of pieces of the divided data in the storage unit in a case where the determination is that there is a free storage area capable of storing the plurality of pieces of divided data.

9. The storage device according to claim 7, further comprising:
determining unit configured to determine whether a first storage unit in the storage unit has a free storage area capable of storing the plurality of pieces of divided data; and
storing unit configured to store part of the plurality of pieces of divided data in the first storage unit and store the other remaining pieces of divided data in a second storage unit in the storage unit, the part being determined based on the free storage area of the storage unit, in a case where the determination is that the first storage unit has no free storage area capable of storing the plurality of pieces of divided data.

10. The storage device according to claim 7, wherein the number information is stored in a redundant storage area of each of the pieces of divided data.

11. The storage device according to of claim 7, wherein each of the plurality of divided data is assigned identification information identifying the first data and the storage device further comprising reading unit configured to read out the plurality of pieces of divided data having the same identification information from the storage unit.
